(19) United States
(12) Patent Application Publication
(10) Pub. No.: US 2011/0262103 A1
(43) Pub. Date: Oct. 27, 2011

(54) Systems and methods for updating video content with linked tagging information

(76) Inventors: Kumar Ramachandran, Schaumburg, IL (US); Geoff White, Denver, CO (US); Marcus Kwan, Denver, CO (US)

(21) Appl. No.: 12/799,126

(22) Filed: Apr. 19, 2010

Related U.S. Application Data
(63) Continuation-in-part of application No. 12/584,863, filed on Sep. 14, 2009.

(51) Int. Cl. H04N 9/80

(52) U.S. Cl. 386/240; 386/E09.011

(57) ABSTRACT

A system and method associates relevant additional information with a video stream, whether live or pre-recorded. The system creates a spot within the video that is linked to the additional information. When a particular action occurs in relation to the spot, the additional information is presented to the viewer of the video. The action that triggers the action of the spot can be automatically controlled by the system or the action can be a user initiated action. Viewers of the video stream can interact, independently of each other, with the video and be presented with the information associated with the video.

### CROSS REFERENCE TO RELATED APPLICATIONS

This application is a continuation-in-part of and claims priority to U.S. application Ser. No. 12/584,863 filed Sep. 14, 2009, incorporated herein by reference.

### BACKGROUND

The present invention is directed towards systems and methods that permit additional tagging information to be added to a video stream that can then be used to associate content and related aspects of the video stream to additional information. The present invention pertains to systems and methods which add descriptive data and information to video and allows audience members to independently interact with the video while viewing the video.

The ability to access information and the distribution of information have been rapidly increasing. The thirst for information and desire for new ways to obtain information continue to grow. Video has been a popular medium for access to and dissemination of information. The web has also been a popular medium for access to and dissemination of information. However, access to and dissemination of information can be improved. Thus, needs exist for new systems and methods to provide and access information, particularly in relation to video, for the reasons mentioned above and for other reasons. It would be an improvement to provide a new system and method for enhancing or updating video content with additional user interactive information.

### SUMMARY OF THE INVENTION

The present method and system provide a way to accurately, efficiently, and cost-effectively associate relevant information with a video stream, whether live or pre-recorded. The present invention further provides various systems and methods to associate the information with the video, including without limitation, HotSpotting, EventSpotting, VoiceSpotting, and combinations thereof. HotSpotting, EventSpotting, VoiceSpotting, etc. may be referred to as context or context dimensions. Also, the information is associated with the video by a computer system, automatically and/or with assistance by an operator. Viewers of the video stream can interact, independently of each other, with the video and be presented with the information associated with the video. A video player according to the present invention can be web enabled and have a web browser which allows for web content to be associated with the video.

Embodiments of the present invention can provide systems having complete multidimensional context layers for video that includes any combination of multiple spot identification processes. Each spot identification process is a process that identifies a different type of item in the video content. Examples of spot identification processes include, without limitation, a hotspot identification process which identifies a marker carried by an object in the video content (HotSpot), a voicespot identification process which identifies an audio portion of the video content (VoiceSpot), and an eventspot identification process which identifies an event that occurs in the video content (VoiceSpot). The system is able to select (changeable selection) a desired one of the spot identification processes and then link the selected outside information (such as data or ads) to the spot (HotSpotting, EventSpotting, and VoiceSpotting). The linked information, such as data and ads, is presented by to the user based on actuation of a trigger. The trigger actuation can be automatic by the system, such as when a particular event occurs in the video. Alternatively, the trigger can be actuated by the viewer of the video, for example, by clicking on a particular location on the video with a pointing device. The context types/layers can be created/triggered/managed by both the content owner and/or by each individual end user. Embodiments of the present invention can also provide a comprehensive ‘closed loop feedback’ system for context adjustment based on usage by the end user.

Various embodiments of the invention are envisioned. In one embodiment, a method for associating tagged information with subjects in a video is provided, comprising: uniquely marking a subject of the video, using a marking mechanism that is relatively invisible to viewers of the video by virtue of its composition or size, prior to filming the video; providing additional information about the subject of the video; filming the video containing the subject with conventional filming technology, the video containing time sequencing information; providing a position detector capable of reading the unique marking of the video subject at a location where the video is being made; recording, with the position detector, position information of the subject along with the unique marking and further recording time sequencing information that can be associated with the time sequencing information of the video filming; associating the position information of the subject recorded with the position detector with the filmed video to provide subject tracking information in the video; and accessing the additional subject information by a viewer of the video utilizing the subject tracking information.

Other embodiments may be considered as within the scope of the invention as well.

Embodiments of the present invention may have various features and provide various advantages. Any of the features and advantages of the present invention may be desired, but, are not necessarily required to practice the present invention.

### DRAWINGS

The invention is described below with reference to various embodiments of the invention illustrated in the following drawings.

FIG. 1A is a pictorial representation of a video screen showing an image captured with a standard video camera;

FIG. 1B is a pictorial representation of a video screen showing an image captured with an infrared video camera;

FIG. 1C is a pictorial representation of a video screen showing defined regions associated with subjects in a video frame;

FIG. 2 is a block diagram illustrating the components used for HotSpotting;

FIG. 3 is a block diagram illustrating the components used for EventSpotting;

FIGS. 4-7 are exemplary screen shots illustrating an embodiment of the invention in the form of a web page browser view;

FIG. 8 is exemplary screen shot illustrating an embodiment of a video progress bar;

FIGS. 9-13 are representations of screen shots illustrating the creation of a HotSpot;

FIGS. 14a-c are illustrations showing the use of keyframes to move a HotSpot;

FIG. 15 shows an embodiment of a video progress bar;

FIGS. 16-19 are representations of screen shots illustrating viewing and use of a video enhanced with HotSpots

FIG. 20 is a screen shot illustrating an embodiment of the present invention in which various different types of HotSpots can be created for a video.

### DETAILED DESCRIPTION OF THE INVENTION

The present invention can provide systems and methods that tag or link additional information to spots within the video. The additional information is information that would otherwise be outside of the video had the video not been tagged. Each person viewing the video can independently of other viewers interact with the spots in the video to receive the additional information. Embodiments of the present invention provide systems and methods that allow content owners (producers) to create multidimensional context (including advertisement), enable content delivery to end users, measures consumption of the video content as well as the context, and deliver advertisements based on both context/consumption patterns and/or based on ad rules.

In embodiments of the present invention, the system can create a spot within the video as follows. A particular item in the video is selected. For example, a context dimension or trigger is selected, such as an appropriate item for an EventSpot, a VoiceSpot, or a HotSpot, etc. A widget type is selected, in which the widget type is information to be associated or linked to the item in the video. Examples of widget types include, without limitation, URL's, images, videos, overlays, popup windows, graphs, text and any other form of information and combinations thereof. Then, the selected widget type(s) are associated (linked) to the trigger (context or context dimension) to create the tagged video. In this manner a spot (information associated to an item in the video) can be created in the video. The tagged video can be a live video feed which is broadcast or the tagged video can be stored and replayed at a later time. In either case (live broadcast video or replay of stored video) an action that triggers the spot will cause the information to be presented to the viewer of the video. The action that triggers the spot can be automatically controlled by the system or the action can be a user initiated action. The viewer can interact with the tagged video by activating the spots to receive the additional information of the widget type that was linked to the trigger.

Each audience member has their own unique set of interactions with each tagged video (live or replayed from a file). For example, if audience member A is one of 25 people who are watching the same video at the same time on different screens, audience member A can see his interactions on his screen, but the other 24 people in the audience cannot see his interactions. Each one of the 25 people watching the video interact with the video independently of the other audience members.

Context sharing can be another feature of the present invention. End users can create context and share it with friends. The invention allows authors to share portions or all context by video for collaboration. The present invention can utilize the interne or other networking systems to network collaboration on building and enhancing context.

### Hotspotting

In the first aspect of the invention, herein referred to as “HotSpotting”, thermal inks and radio-frequency identification (RFID) mechanisms are used on subjects in combination with infrared cameras or RFID-detectors in order to automatically track subjects. This HotSpotting may be achieved by providing an explicit marking of the subjects prior to them being imaged. In a preferred embodiment, the subjects are marked using thermal inks or RFID prior-to imaging. An infrared camera is then used to detect the marking that was previously placed on the subject.

This concept could be applied to any situation in which subjects are to be tracked. By way of example, the players in a sporting event could have their jerseys uniquely marked in some manner. For example, the player's number on his jersey could be additionally painted with the thermal ink, for example, in order to make identification of the player easier throughout, the game. This could be done on the front, back, and sides to enhance the ability to recognize the player.

In another example, a model could have the outfit she is wearing uniquely identified. In this situation, the unique identification could be associated with the particular outfit the model is wearing. Since the thermal ink is invisible to the naked eye, it would not serve to distract either direct viewers or those viewing via a video signal obtained with a standard video camera. Since the thermal ink is visible to the thermal camera, identification markings can be readily recognized by the infrared camera.

Many other examples can also be presented for this concept. The marking could be utilized on any television show or movie to track the subjects and permit their ready identification to the viewing public. The concept is not limited to people, but could also be implemented for animals or inanimate objects as well. The concept is that this design does not rely upon the error-prone recognition techniques based solely on a traditional video signal.

With RFID, geo-locations can be obtained over a period of time. Then, knowing the spatial co-ordinates, this information can be mapped to the video co-ordinates and the subject can be determined in this manner. Such an arrangement is more complex and less accurate than use of the thermal ink. But this arrangement is useful for situations where thermal ink is not possible to use.

In this way, one or many subjects can be identified in a video frame that can then be associated with additional sources of information. The HotSpotting is ideally suited for media content with a long shelf life or popular content with a shorter shelf life, where the association of additional information can provide a substantial return on investment for the setup effort that is required for all of the marking.

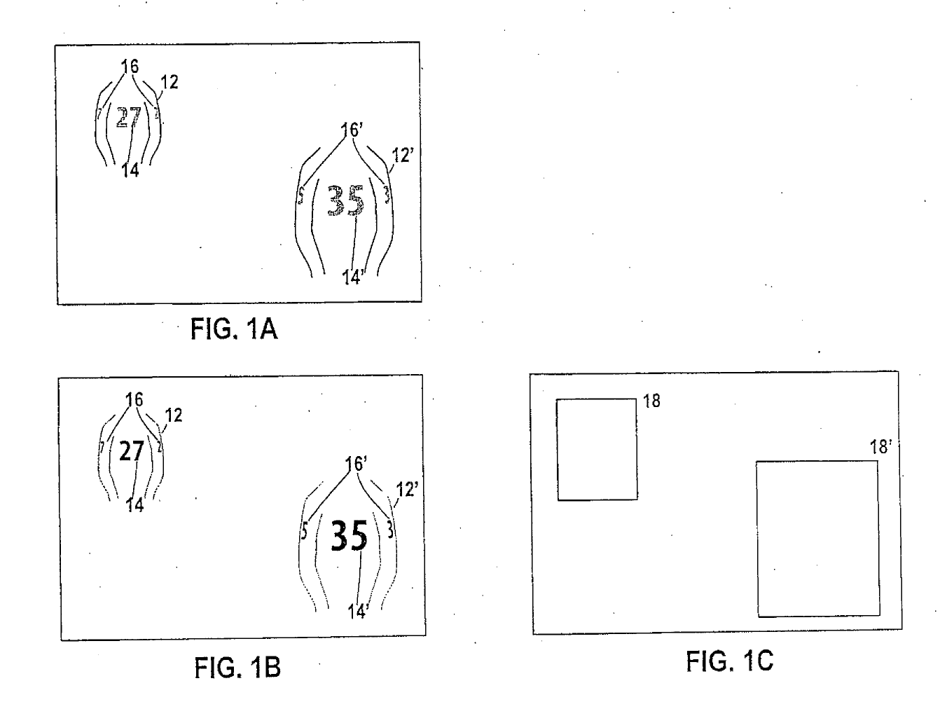

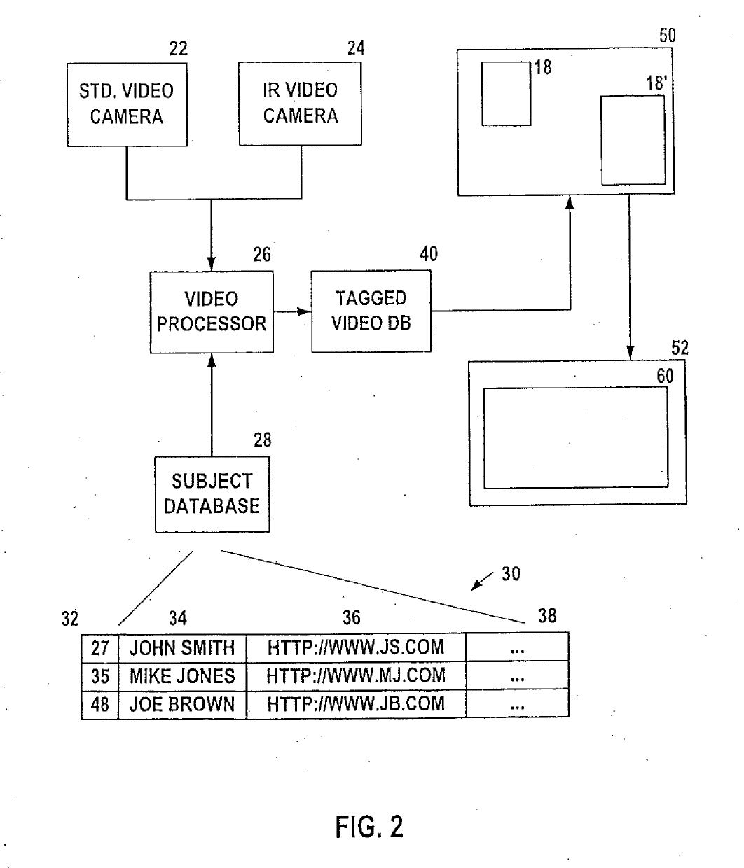

Referring to FIGS. 1A-C and FIG. 2, illustrating an exemplary embodiment where two players' jerseys with the numbering painted in thermal ink are captured in a video frame, FIG. 1A illustrates two jerseys 12, 12′ captured using a standard video camera 22. The jerseys 12, 12′ comprise a large rear number 14, 14′, and smaller arm numbers 16, 16′. It should be noted that for traditional sports jerseys, the player's number could be painted with normal ink or dye for viewing by spectators, and additionally painted with thermal ink for clear viewing by the IR video camera. However, where these are, e.g., clothes for a model, then it is desirable that these markings be invisible under normal lighting to spectators, but visible to the infrared camera.

FIG. 1B illustrates the same jerseys 12, 12′ captured using the IR video camera. As can be seen, the numbers that use the thermal ink are much more prominent and are therefore more easily recognized by the video processor 26.

Prior to the event being recorded, a subject database 28 has been assembled. The database 28 contains subject records 30 that relate to the subjects that may be present in the video being recorded. The record 30 contains some form of a unique identifier 32 (for example, the player jersey numbers), and may contain some other form of identifying indicia 34, such as a name or other descriptor. Additional relevant information 36 can be provided that is preferably in the form of a link to where additional information can be located. In a preferred embodiment, such a link could be a hypertext markup language (HTML) link that specifies a web site where additional information could be located. However, other information 36, 38 besides links/pointers or in addition to links/pointers can also be included in the subject records 30.

The video processor 26 receives video feeds from both the standard video camera 22 and the infrared video camera 24. It should be noted that, ideally, these cameras 22, 24 are represented in the same physical device that provides a separate feed for both the standard video and the infrared video. Such a camera could implement appropriate filtering for segregating the normal/standard and infrared video. Using the same camera eliminates registration issues associated with using two cameras in that the two cameras 22, 24, might not point to exactly the same scene and the images would have to be aligned in some manner.

The video processor 26 processes the infrared video camera 24 signal to determine the coordinates or regions for the video frames in which the identifying indicia 12, 14, 16 can be located. Then, for each frame, or possibly groups of frames, calculates a bounded region 18, 18′ for each of the subjects in the video frame. Although a rectangle is a preferred shape for a bounded region, there is nothing that prevents other geometries (such as a triangle, regular polygon, irregular polygon) from being used, although the determination of such regions may require more intensive computational resources. The rectangle or other shapes could be used also when a fixed-object, such as a scoreboard at a sports arena, is used as one of the subjects.

In any case, the video processor produces a video file, which may be in any standard format, such as Windows Multimedia Format (WMF), MPEG-2, MPEG-4, etc., based on the standard video signal received, but then tagged with the predefined regions 18, 18′, and stored in a tagged video database 40. The predefined regions 18, 18′ stored in the video database 40 can be associated with or linked to additional information. In this way, the present invention can automatically identify one or more items in a video and link additional information to those items.

A user, on their own computer, can then view video files from the tagged video-database 40. As illustrated in FIG. 2, the user's display 50 presents the video frames with the predefined regions 18, 18′, which would generally be invisible to the viewer, although there could be a rollover function where, when a pointing device, such as a mouse, points to such a predefined region 18, 18′, the region highlights so that the user can know a link exists. The regions could also be lightly outlined or shaded to let the user know that these regions exist without a rollover or pointing. This could be a user-selectable or definable (type of indicating, such as outlining, filling, color, etc,) feature so that the defined regions 18, 18′ in the video are not distracting.

When a user is watching a video thus tagged, and selects, e.g., with the pointing device, one of the predefined regions 18, 18′, the additional content 60 may be accessed and may be displayed to the user. In one embodiment, the video is paused and the additional content is displayed on the user display 50. The video can resume once the user has finished accessing the additional content (although it is possible to have the video continue to run as well). Alternately, the additional information, such as statistics for a player in a sporting event, could be displayed in a superimposed manner on the display.

The additional data associated with the subject regions could be assigned on a per-time basis. In other words, a first web site could be pointed to for the region associated with player #35 for the first half hour of the video, and a second web site for me next half hour of video. In this context, one mechanism for revenue generation that could be provided is that a subject, such as a player, could allocate certain blocks of time allocated to his region 18 to various advertisers. Thus, e.g., for the first thirty seconds of each half hour, the additional information points to an advertiser instead of, e.g., the player's stats. Alternately, the destination of the additional information itself could change periodically so that a common pointer is used throughout the video.

In a further embodiment, the user has a second display 52 upon which the additional content 60 is displayed. Here too, the video can be paused, or can continue to play as the additional information is presented. In an embodiment, the user selecting a predefined region 18 invokes an HTTP hyperlink to a web site that is then displayed in a web browser of the user.

The above implementations are described with reference to a two-dimensional implementation in which the frames of the video are analyzed in terms of x-y coordinates. However, in an embodiment of the invention, a three-dimensional representation can also be provided. RFTD tags can be associated with global positioning systems (GPS) in order to generate the relevant 3D information. In this way, 3D information associated with subjects in a video can be provided. Computer viewers could access the information in a virtual reality space for a fuller experience.

### Eventspotting

In the HotSpotting mechanism described above, specific-prearranged markings were provided for subjects in a multimedia presentation/video. As noted above, such a system ideally is designed for long-duration media content in which potential revenues justify the set-up costs associated with production.

However, in many situations, it is preferable to associate the additional information with media that has a shorter shelf-life duration, and thus does not warrant the setup efforts associated with the above-described marking. Additionally, in certain situations it is desirable to associate the additional information with an event, not a subject, of a particular point in the video.

For example, in a news presentation, a discussion about a particular company might trigger a desire for a viewer to access the company's history, stock information, etc. In this situation, it is desirable to tag relevant information generally in real-time as the information is being presented. This can be useful, e.g., during a later video broadcast of a taped program. For example, when watching a taped program, all of the charts that are displayed can be current ones (and these charts can even be displayed in comparison to the original (previously-current) chart from the original live broadcast). For example, an updated stock price chart could be included, as opposed to the original stock price chart at the time of the original report. The system can obtain and display publicly available data and information. Furthermore, the system can also obtain and display proprietary data and information, for example, from behind firewalls.

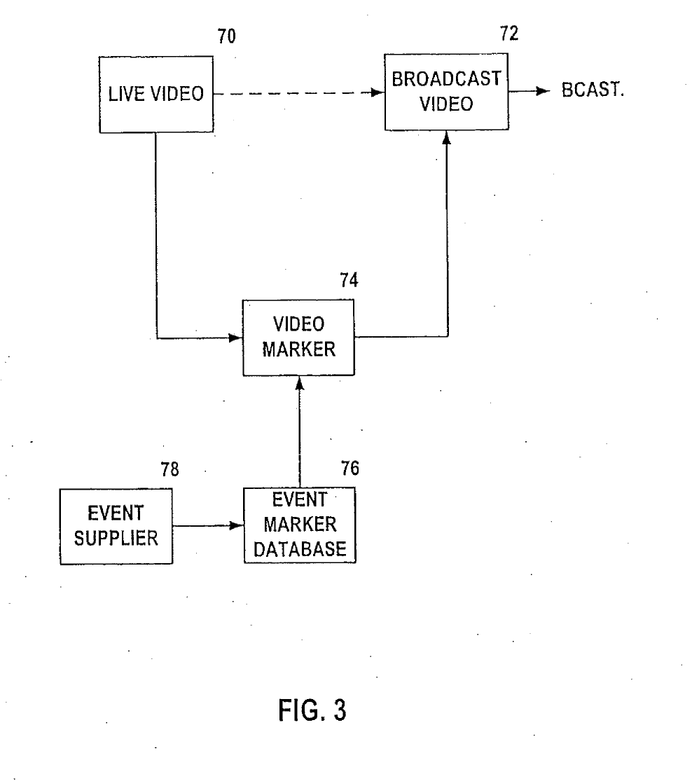

FIG. 3 provides a basic illustration of an embodiment that can be used for the EventSpotting. And, by way of example, a business newscast in which three companies will be highlighted will be described below.

In live broadcasting, it is almost universal that a seven to fifteen second delay is introduced between the live video 70 and the broadcast video 72 for various reasons. All of the Spotting techniques, e.g., HotSpotting, EventSpotting and VoiceSpotting, take advantage of this delay, and are able to use the delay to introduce relevant markers into the video stream that can be used or accessed by viewers.

Accordingly, a person serves as a spotter or a video marker 74 who receives a live video 70 feed and performs the relevant marking on the video. This is done in a similar manner as the addition of closed captioning that is added for the hearing impaired. However, what is different from the closed captioning application is that the information that must be added in real time is more complex and detailed, and so such information cannot simply be typed in.

In order to assist the person serving as the video marker 74, an event marker database 76 is provided. This event marker database 76 is preloaded with potential events by an event supplier 78 in advance of the event. Using the example above, the business newscast is known to contain information about three companies: Motorola, Starbucks, and Wal-Mart. The event supplier 78, knowing some time in advance (with perhaps as little as five minutes' notice) is able to assemble, e.g., relevant hyperlinks directed to the web sites of the three respective companies, or possibly to the web sites of some other content supplier with information related to the three companies.

The relevant event markers, one for each of the companies, is stored in the event marker database 76 prior to the business newscast. Once the newscast starts, the video marker 74 can simply select an event from the database and assign it to the video at the proper time and in the proper place. So, as the live video 70 discusses Motorola, the video marker 74 selects the Motorola event marker from the database 76 and associates it with a particular temporal segment of the video. The relevant hyperlink could just simply be associated with the entire video display during the presentation of the Motorola segment, such that a user clicking on the video segment during the Motorola presentation would be directed to the appropriate address for additional information. Alternately, the word “Motorola” could be superimposed on a part of the screen so that the user would click on it and be directed to the appropriate address.

In addition to a pure temporal designation by the video marker 74, however, bounded regions, such as the rectangles described above, could be integrated in, although in a live feed situation, it would be difficult to manually address more than two or three bounded regions in real time.

However, in such an instance, multiple video markers 74 could be utilized for marking the same live video 70 in an overlaid manner, each of the video markers 74 having one or move events from the event marker database 76 for which they are responsible for.

The regions could be drawn in using traditional drawing techniques. For example, a rectangle drawing tool could be used to draw a rectangular region on the display - this region could be associated with a particular event, and the region drug around on the screen as the subject moves. As the video is marked, it is sent out as the broadcast video 72 to viewers of the content. Again, a streaming video format could be utilized for the broadcast, having superimposed links to other relevant data incorporated.

Ideally, the event marker database 76 does not contain a huge number of possible events for a given video segment, since a larger number of events in the database 76 makes it more difficult for the video marker 74 to locate the relevant information. However, the marker database 76 should be relatively complete. For example, for a sporting event, the database 76 should have relevant information on all of the players in the game, each of the teams in the game, and other relevant statistics, such as (for baseball) number of home runs, etc.

In a sporting event, some example applications could be that when a home run is hit, a link is set up for the player hitting the home run, and/or for statistics related to team home runs or total home runs.

It should be noted that the EventSpotting described above could also be associated with the previously discussed HotSpotting. This permits a further ability to access information. For example, during a movie, by clicking on an actor during a certain period of time (HotSpotted), links to all of the actors in a particular scene (the scene being the event) could be displayed as well (EventSpotting). Or, by clicking on the actor, a list of all of the scenes (events) in which the actor participates could be provided.

### Voicespotting

As with the other two methods of spotting (HotSpotting and EventSpotting), VoiceSpotting deals with associating relevant information to portions of the video stream. However, with VoiceSpotting, a real-time association of the additional data with content of the video information is achieved through the use of automated voice recognition and interpretation software. Thus, FIG. 3 applies in this situation as well, except that the video marker 74 comprises this automated voice recognition and interpretation software.

In VoiceSpotting, the live video feed 70 is provided to a well-known voice recognition and translation module (the video marker). Here, the module recognizes key words as they are being spoken and compares them with records stored within the event marker database 76. Of course, the marking that is provided is generally temporal in nature, and, although the hyperlinks could be displayed on the screen (or the whole screen, for a limited segment of time, could serve as the hyperlinks), intelligent movement and tracking on the screen would be exceptionally difficult to achieve with this mechanism.

However, the VoiceSpotting technique would be more amenable to providing multiple links or intelligently dealing with content. For example, if the word “Motorola” were spoken in a business report, the video marker could detect this word and search its database. If “Starbucks” were subsequently mentioned, both the words “Motorola” and “Starbucks” could appear somewhere on the display, and the user could select either hyperlink and be directed to additional relevant information.

It should be noted that where two user displays are used, it would be possible to provide the links themselves, and/or the additional data on the second display so as to provide minimal disruption to the video stream being played by the user.

### Combination

It should be noted that any combination of these three spotting mechanisms could be combined on a given system to provide the maximum level of capability. For example, the VoiceSpotting could be used to supplement the EventSpotting or the HotSpotting.

A system providing complete multidimensional context layers for video that includes conventional HotSpotting, thermal HotSpotting, EventSpotting, and VoiceSpotting). These context types can be created/triggered/managed by both the content owner and/or by each individual end user. The system can also include a comprehensive “closed loop feedback” system for context adjustment based on usage. Thus, with the end-user, if a user notices an event or voice commentary that does not have a previous cataloged asset to view, they can create it in the viewing player itself and share it with others. So the creating and updating of these Spots are constant both at source and at the consumption end.

The video player provided to the end user preferably includes one or more web browsers to provide web-context to the video. URLs can appear along with video in the browser and when user is browsing the web, the video can pause and then automatically start when browsing stops. URL's can be secure and unsecure and the ops platform will be able to code it as context.

All context enhancements (such as URLs, images, charts, voice, etc.) can be automated or manually input by human operators, although some is better suited for automation than are others. Although automation has some advantages, human intervention generally results in the most accurate and granular context enhancements, where-practical. Thus, the present system makes it easy and quick for skilled workers to add/adjust context enhancements.

All context elements (both automated and human-generated) can be measured against real end user actions in the live video 70. As to an evolution in determining which aspects or the various spotting techniques are most effective, end user actions can be correlated and computed to determine which spotting mechanisms have been interesting and effective based on usage. A feedback analysis can help content providers adjust internal thresholds so the system benefits the larger audience. This constant feedback loop between the users of the system and the taggers of the video will make the tags more accurate and valuable.

The data for any charts can be obtained in real-time and pulled from any server in the world at the time the video is played by the user. This can be useful, e.g., during a later video broadcast of a taped program. For example, when watching a taped CNBC Financial Report, all of the charts that are displayed can be current ones (and these charts can even be displayed in comparison to the original (previously-current) chart from the original live broadcast). This real-time data aspect is a unique feature. For example, an updated stock price chart could be included, as opposed to the original stock price chart at the time of the original report. The system can obtain and display publicly available data and information. Furthermore, the system can also obtain and display proprietary data and information, for example, from behind firewalls.

All data elements that are displayed as context next to the video can be made “drillable”. For example, if a context element is presented regarding “GE” in a financial report, or a “dress by Vera Wang” in a fashion show, the user can click into the context element to get more data on this term.

The customizable workflow can enable each content provider's production team to tailor it to the way that the team works (with approvals, rendezvous, etc.). It automates many of the tasks including feeding the right context to the human operator's visual area to help speed up the process. Furthermore, end users can create context and share it with friends, permitting, e.g., authors to share portions or all context by video for collaboration.

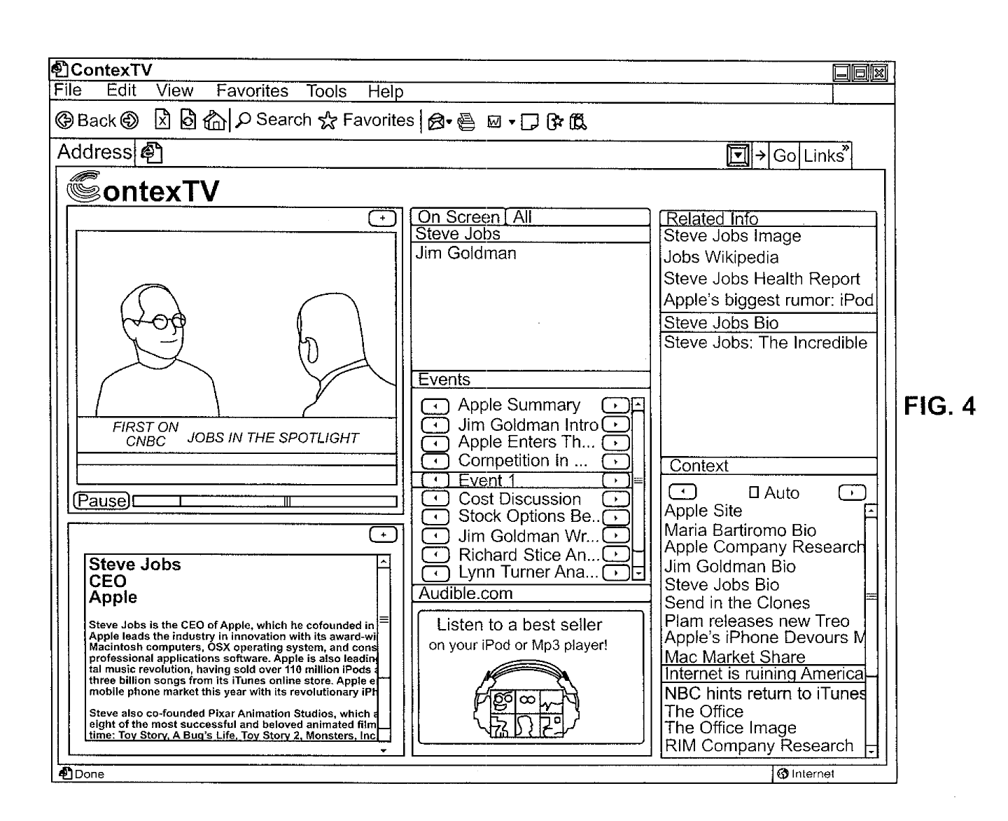

FIGS. 4-7 provide exemplary screen shots of a browser-based implementation. The upper left-hand windows show the tagged video, and the user may select various regions within the video for additional information. In FIG. 4, an interview with Steve Jobs is presented in the upper left-hand screen having tagged information. In the topmost center region, two tabs are provided so that relevant hyperlinked information can be limited to what is shown on, the screen, or another tab can allow the user to chose from all relevant data.

In the “Events” region below, the user can select various events that have occurred related to the interview and then view these events. Advertisement information can be provided as a revenue-generating mechanism for the video. Advertisements can be presented to end users, and the system can accurately measure and report which ads have been served to which viewers. Multiple advertising models are supported including standard web impression/CPM based campaigns, cost-per-action campaigns and measurable product placements. Click through to ecommerce purchase opportunities are also supported and can be measured. A related information box is provided in the upper right-hand corner where the user can select various related information to what is being shown in the video, and can provide hyperlinks to the additional information.

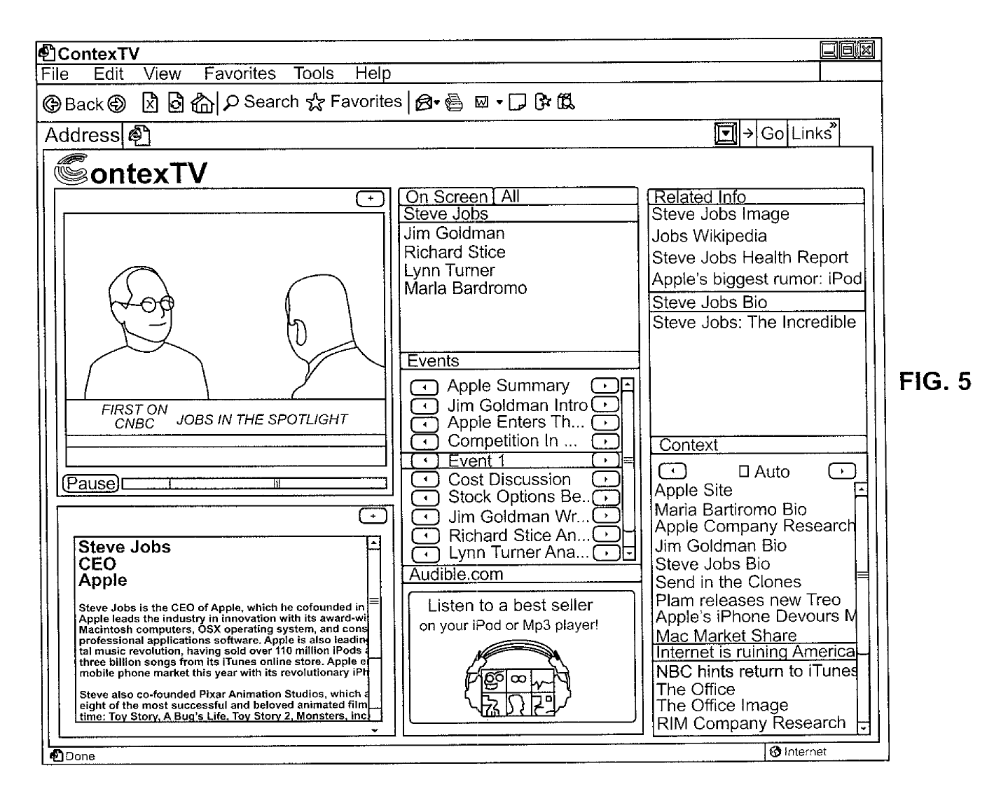

FIG. 5 illustrates a display similar to FIG. 4, but where the viewer has selected the “all” tab instead of the “on screen” tab for indicating that all relevant information should be provided, instead of only that related to what is currently being shown in the video display.

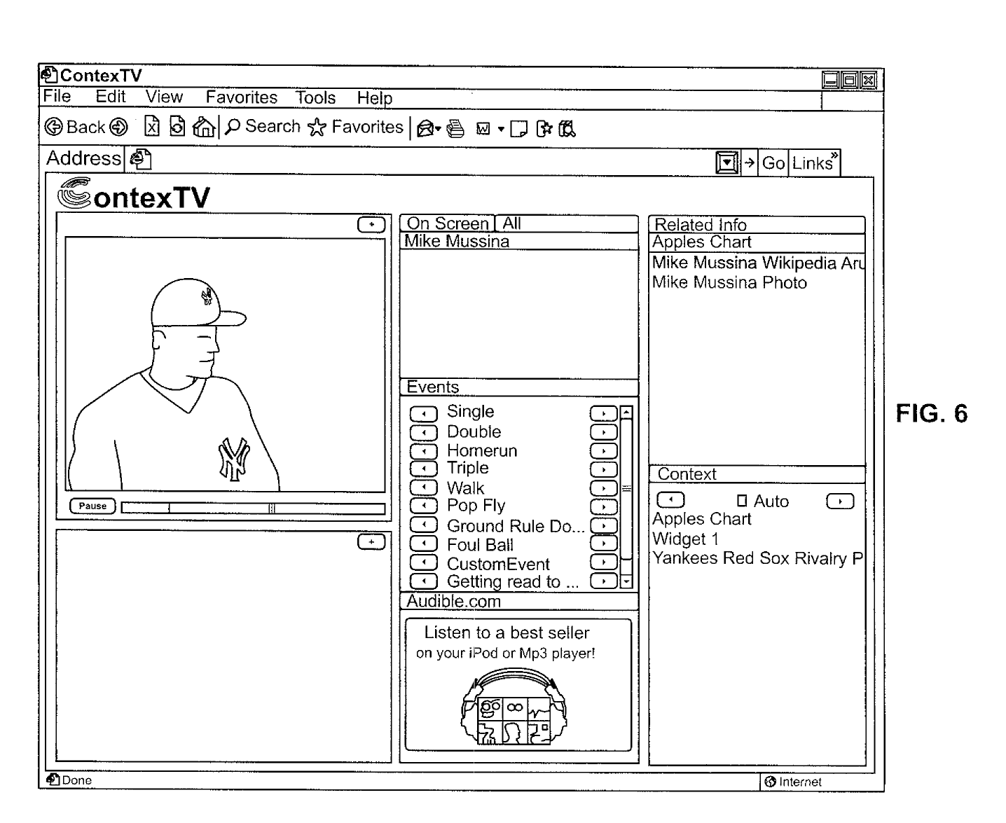

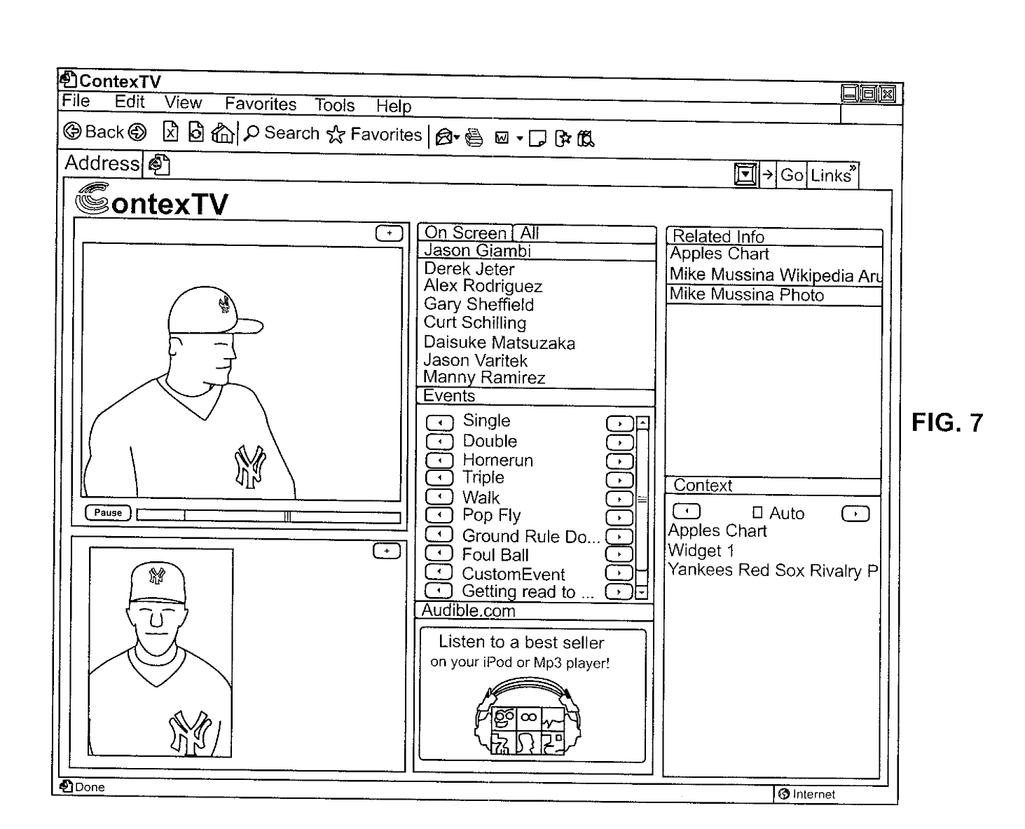

FIGS. 6 and 7 are similar to FIGS. 4 and 5, except as applied to a baseball game.

Embodiments of the present invention can provide various features and advantages. For example, a benefit to the audience can be that the descriptive data presented with the video enhances the viewing experience. There can be at least three broad categories of value added to the audience. One category is trusted, valuable data. The descriptive data (such as “metadata”. “contextual data” or “context”) can come from credible sources and is relevant to the video's subject matter. The data or information is likely to be interesting to the audience and lead to more content consumption and time spent on the site. A second category is special offers. The contextual data or information can be in the form of coupons, discounts, special limited offers, etc, that are available only to “insiders” who can access the data/information of the tagged video. A third category is communication with other viewers. It is valuable for the audience to communicate with other audience members and share information (reviews, community building, etc.)

Embodiments of the present invention can also provide benefits to content owner (publisher or producer). A benefit to the content owner can be to assist in monetizing the content. Given the enhanced end user experience offered to the audience described above, there should be increased opportunities to sell in interesting ways to larger, more loyal audiences. The content owner can determine exactly which contextual data (information) is added to each video. How and when each element of context is triggered to appear to the audience is another part of the system that that can be defined or controlled by the content owner. Each element of context can be triggered by either the content owner (producer) or the audience member(s).

In embodiments of the present invention, presentation of context data (information) can be producer driven or audience driven. In a producer driven presentation, the content owner decides not only what context shall be available to enrich each video, but also determines when each contextual element is presented to the customer. A couple of examples follow.

Example (a). When watching Seinfeld, Snapple presents a coupon whenever someone opens Jerry's refrigerator or a character says the word “Snapple”. The coupon appears for 30 seconds after the refrigerator door opens or the word is said.

Example (b). One could be watching a fashion show that it is a show with unknown models wearing clothing from midmarket brands like J Crew and Banana Republic. The producer will force each model's bio summary to appear when that model is on the screen. If the viewer wants more information on a particular model, the context will reveal the model's publicity page.

In an audience driven presentation, an explicit action by an audience member (such as a mouse click) triggers the context (but only context that the producer has added to the video) to appear. A couple of examples follow.

Example (a) In the TV series ‘Seinfeld’, many famous actors are featured as guest stars. If an audience member clicks on a guest character who looks familiar to them, the actor's IMDB or Wikipedia page can appear to the audience member who can browse the actor's other work.

Example (b). In the fashion show example described above, the user can click on the various clothing items worn by each model, and the page from jcrew.com that describes the item in detail will appear. There will be an opportunity to purchase the item from the J Crew site, perhaps with a special discount associated with the fact that the viewer attended the online fashion show.

HotSpotting, VoiceSpotting and EventSpotting have been referred to as examples types of context in the systems of the present invention. Further examples of those contexts will now be described.

HotSpotting can be a form of audience-triggered context association where a user clicks on a specific area of the screen that contains an actor, an object (building, animal, the sky, etc.). Once identified, the system will ‘remember’ the HotSpotted object throughout the remainder of the video file. Examples (a) and (b) above in the audience driven presentation category are HotSpotting.

VoiceSpotting can be a form of producer triggered context association. For example, when a specific word is mentioned in the audio track of a video file, an action is triggered. For example, whenever a financial news anchor mentions any company listed on the NASDAQ or NYSE, the chart for that company can appear in a web page.

EventSpotting can be a form of producer triggered context association where a specific event in the video (such as a goal in a hockey game, or a mention of a specific topic in an interview) triggers context to appear.

The present invention can be practiced with a wide variety of hardware devices. The hardware device must, of course, be able to display the video and any additional information that is associated with the video. Also, in embodiments where the viewer of the video (user of the system) interacts with the video, the hardware device has a mechanism for the user input to interact with the system. Examples of hardware devices that may be suitable for use with the present invention include, without limitation, computers, internet phones, Apple IPhones, smart phones, video game systems, televisions, devices with video displays and internet access, and other devices.

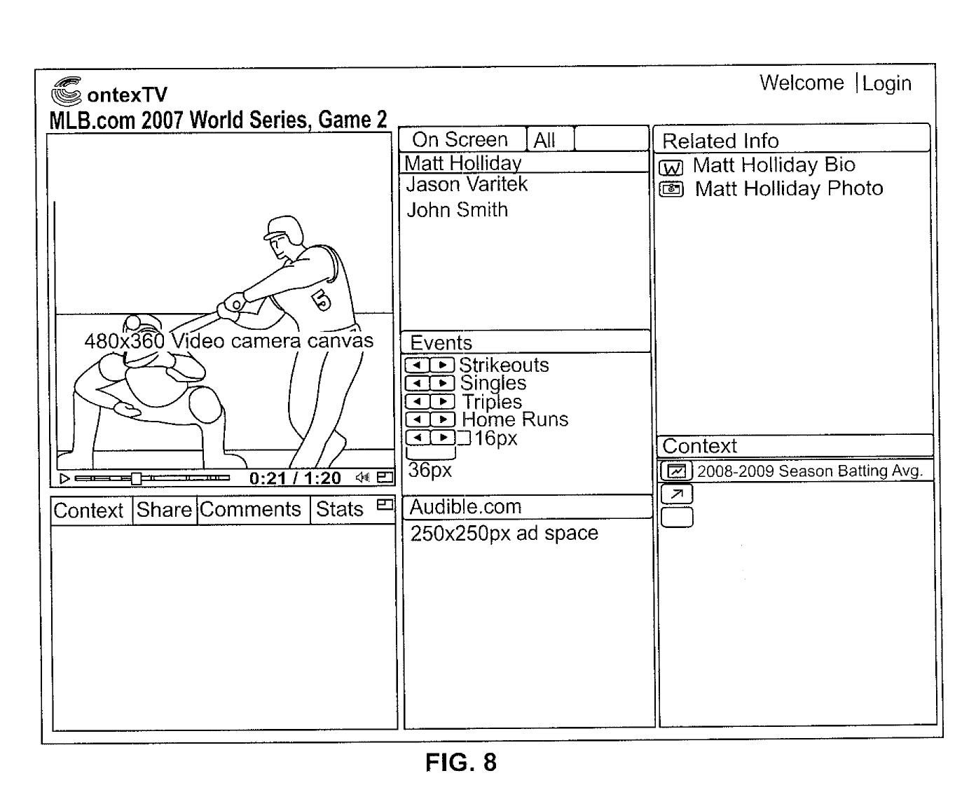

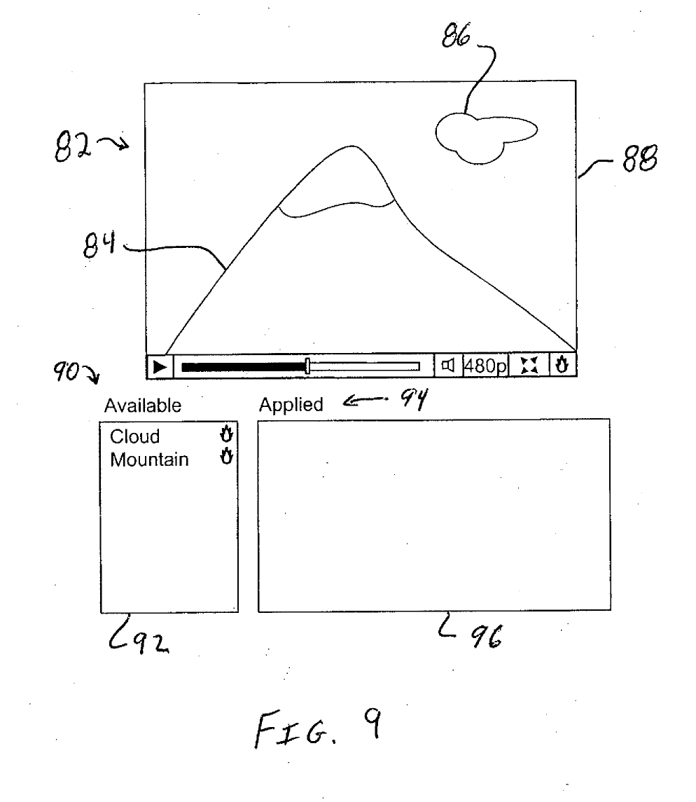

The present invention can also provide a video progress bar context to the video. The video progress bar is a visual arrangement that highlights the scenes in the video specific to one or many spots. For example, in a baseball game video, the system recognizes that the user has clicked on the pitcher Roger Clemens from the HotSpot area and “strikeouts” from the EventSpot area. The progress bar can have several colored bands to show where the event and the pitcher occur together in the video, i.e. all of the strikeouts in the baseball game pitched by Roger Clemens. Users can pick one or many spots and the progress bar will color highlight the area in the video where the spots occur. Users can just click that area and the video player will play the video from the start of that area. This feature can help users consume the video in interesting and useful ways. Referring to FIG. 8, an example of a video progress bar 80 is shown in relation to a baseball game.

Further embodiments of the present invention will now be described with reference to FIGS. 9-20. More specifically, the creation of a HotSpot in a video 82 will be described. User interaction with the HotSpot will also be described. Referring to FIG. 9, a computer-based HotSpotOpsDesign system and method creates one or more HotSpots in the video 82. The HotSpot enhances the video 82 by providing additional content about content items in the video 82, for example, information about mountains 84 or clouds 86 appearing in the video 82. FIG. 9 is a representation of a screen shot from a display screen of the HotSpotOpsDesign system. The video 82 showing the mountain 84 and the cloud 86 is playing in a video portion or window 88 of the display screen. The video 82 can be started by clicking on a video play button as is know in the art. The HotSpotOpsDesign system also provides a list of available meta data objects 90 or information identifiers in another portion or window 92 of the display screen. The information identifiers 90 in the list 90 and associated meta data objects can be contained and maintained in an information identifier database. Preferably, only information identifiers relevant to the video 84 are displayed in the list 90. HotSpotOpsDesign system further provides a list 94 of meta data objects or information identifiers that have been applied to the video 82 in another portion or window 96 of the display screen. The list of applied information identifiers 94 is shown as blank in FIG. 9 as no information identifiers have yet been applied to the video 82.

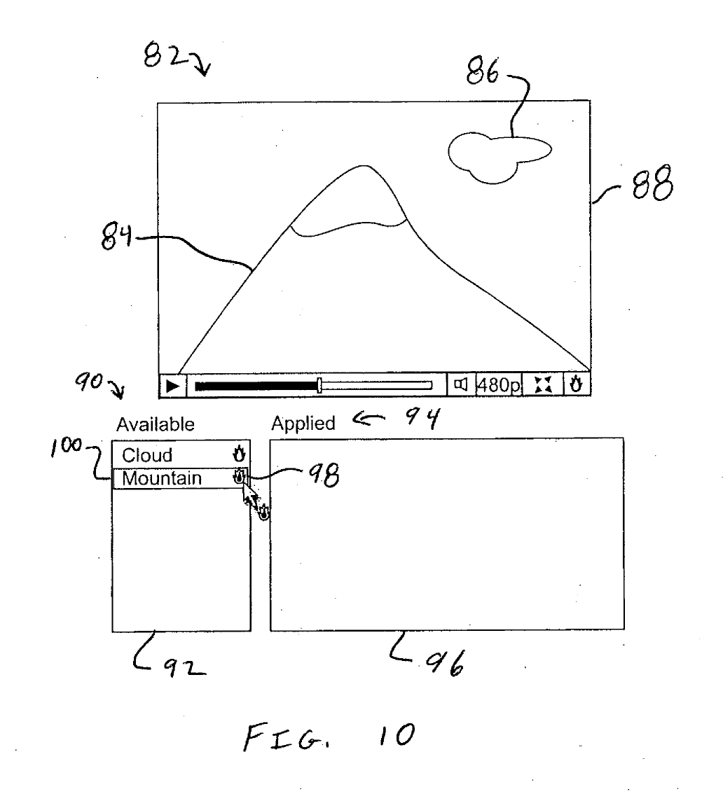

Referring to FIG. 10, the HotSpotOpsDesign system is placed in a HotSpot mode. The HotSpot mode is entered by clicking, or otherwise actuating, a HotSpot icon 98 in the list of available information identifiers 90. The selected information identifier 100 may change appearance, such as a color change, to indicate it has been selected. The HotSpot icon may also appear next to the curser (the arrow in FIG. 10) to indicate the HotSpotOpsDesign system is in the HotSpot mode. FIG. 10 shows the information identifier “Mountain” 100 has been selected from the list of available information identifiers 90. The operator or spotter of the HotSpotOpsDesign system has selected the mountain information identifier 100 because the spotter wishes to add a HotSpot to the mountain 84 appearing in the video 82. Of course, any other suitable indicator could be used to provide a representation that the HotSpotOpsDesign system is in the HotSpot mode. The HotSpot mode could be entered in other ways as well. For example, the arrow curser could be placed over the desired information identifier in the list of available information identifiers 90 and then a keyboard command, for example CTRL+Shift+H, can be actuated. The HotSpot mode can be exited as desired, for example by pressing the Esc key. When the HotSpot mode is exited the HotSpot icon should be released from the curser.

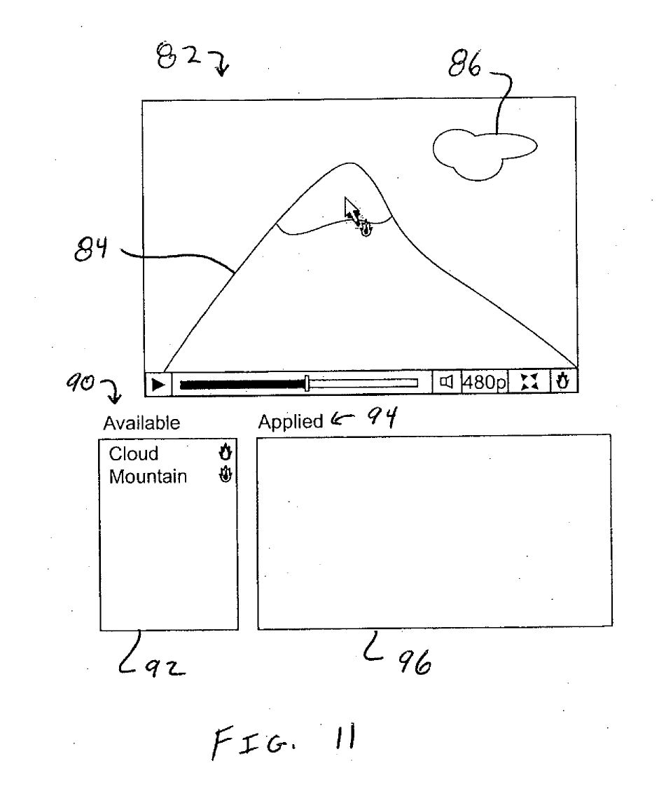

Referring to FIG. 11, the HotSpotOpsDesign system is still in the HotSpot mode and the curser having the HotSpot icon is positioned to hover at the desired content item in the video 82. FIG. 11 shows the curser and HotSpot icon positioned on the mountain 84 in the video 82. The curser and the HotSpot icon should be located at a position where one who is viewing the enhanced video 82 at a later point in time will intuitively understand that the HotSpot icon pertains to the mountain 84.

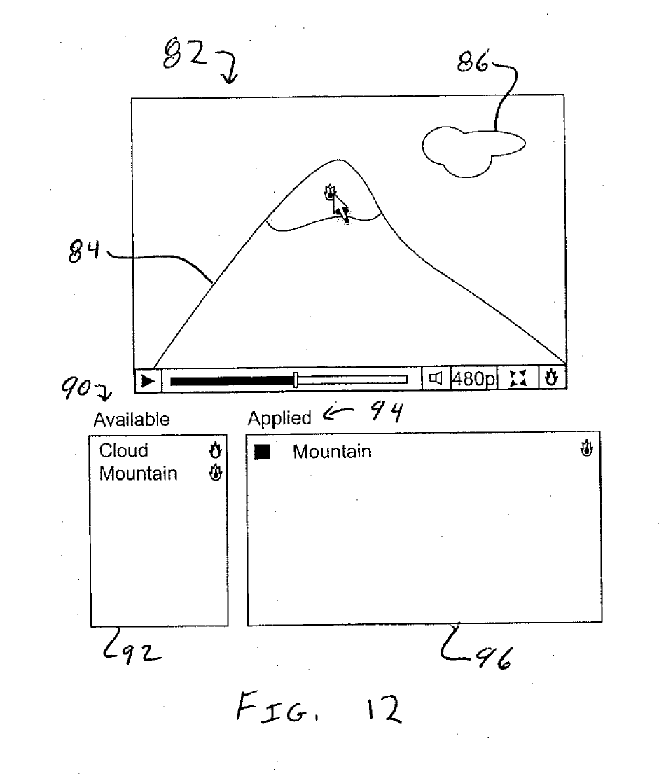

HotSpotOpsDesign system applies the HotSpot to the video 82 by clicking on the video canvas as shown in FIG. 12. The HotSpot and the HotSpot icon are applied to the video 82 at that particular point in the timeframe of playing the video 82. The information identifier 100 and the HotSpot icon will now appear in the list of applied information identifiers 94. The HotSpot icon also appears at the selected location in the video display window 88, e.g., on the mountain 84. The applied HotSpot continues to remain active until it is designated as being ended or otherwise deactivated or disabled. It is desirable to apply the HotSpot to the video 82 close to the point in time when there is a new appearance of the content item, e.g. appearance of the mountain 84. It may be desirable to start the HotSpot within about 5 seconds of the appearance of the content item, i.e., within 5 seconds prior to appearance of the content item or within 5 seconds after appearance of the content item. Similarly, the HotSpot should be ended within about 5 second prior to or within about 5 seconds after the content item no longer appears in the video 82.

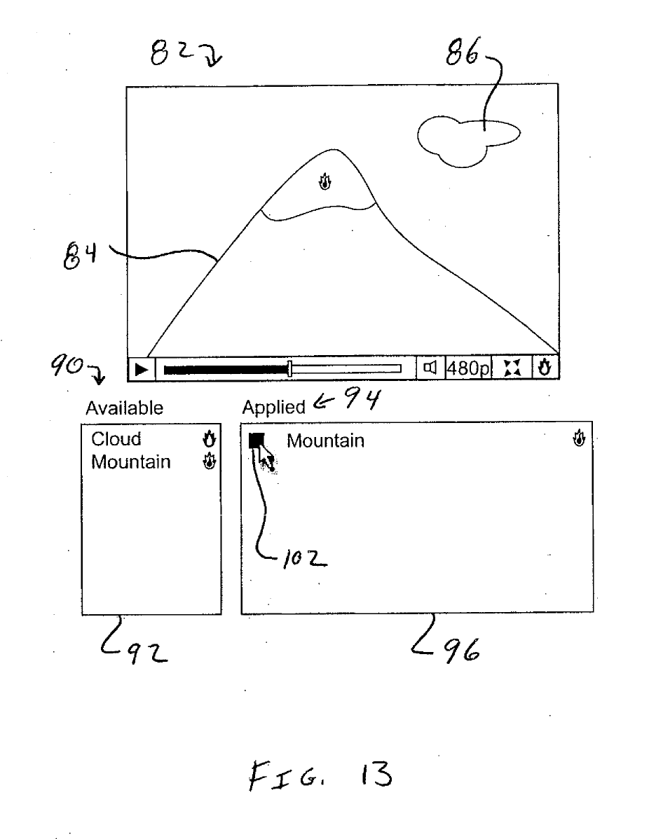

Referring to FIG. 13, HotSpotOpsDesign system ends or deactivates the HotSpot by clicking or actuating a HotSpot end button 102. For example, a stopwatch icon may be provided in the list of applied information identifiers 94 (HotSpots) which can be clicked to end the HotSpot. The stopwatch icon or other portion of the particular applied information identifier may change appearance, such as color, to indicate whether the HotSpot is active or inactive at that particular point in the timeframe of playing the video 82. The HotSpot icon disappears from the video 82 when the video 82 is played beyond the HotSpot end point.

HotSpotOpsDesign system also provide for editing of the applied HotSpots. For example, the location of the HotSpot icon in the video 82 can be changed if desired, for example, by clicking on the HotSpot icon and dragging the HotSpot icon to a desired location. The ending point of an applied HotSpot can be changed as well. The HotSpot icon can be right-clicked to remove the ending point and a new ending point can then be applied. The HotSpot and HotSpot icon can be deleted from the video 82 by selecting the desired applied HotSpot and actuating a delete sequence, such as pressing the delete key or pressing the X key or right-clicking and selecting delete HotSpot from a list, etc. The HotSpotOpsDesign system also has features to control playback of the video 82 to provide for better control of HotSpotting. For example, the video 82 can be paused, played forward at various speeds, reversed at various speeds and can be jumped to any desired point in time of the video 82. Also, the HotSpotOpsDesign system may change the appearance of any icon or any portion of the available and applied lists 90, 94 to indicate a particular status. For example, the appearance of the HotSpot icons and/or the stopwatch icon may change depending on whether an end point has been designated for the HotSpot and/or whether the HotSpot is active at that particular point in time of video playback.

A content item may remain in the same location within the video viewing area or the content item may change positions within the video viewing area. If the content item remains stationary or relatively stationary, then the HotSpot icon created for the content item can also remain stationary. However, if the content item sufficiently changes position within the video viewing area then the HotSpot icon should also change position. Otherwise, the HotSpot icon may become visually separated away from its content item and may visually appear not to be associated with its content item. Accordingly, a HotSpot icon should change its position in relation to a change in position of its content item.

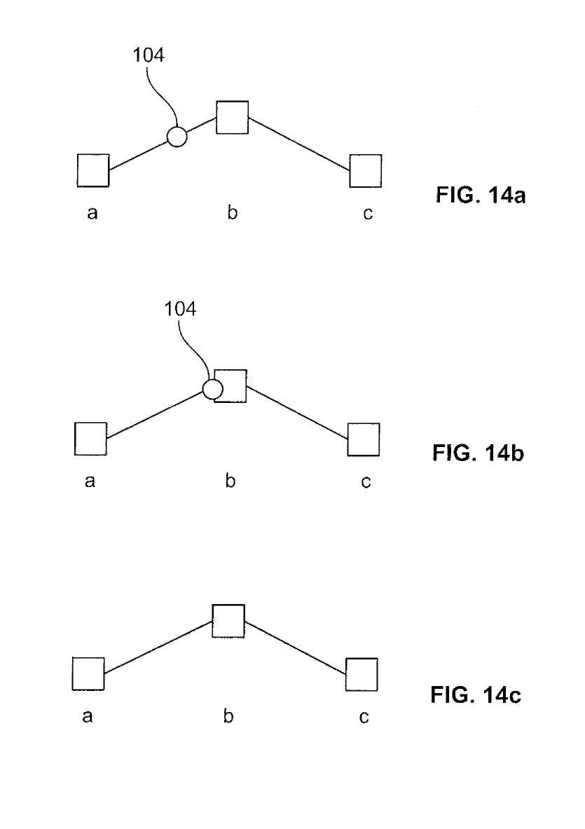

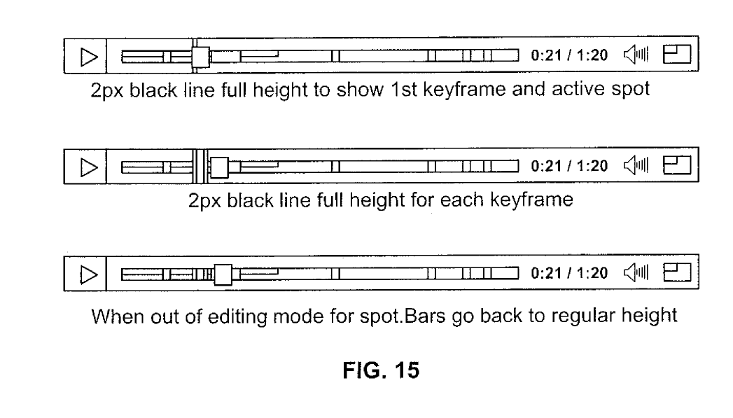

Referring to FIGS. 14a-c, one way to change the position of the HotSpot icon in relation to the change of position of the content item is by using keyframes. In FIG. 14a, the content item and its HotSpot icon 104 (circle) start at the position of the circle. The content item moves from its starting point to keyframe “a,” for example in 5 seconds. The HotSpot icon 104 should also move from the starting point to the location of keyframe “a” in the same amount of time, i.e. 5 seconds in this example. Next the content item moves from the location of keyframe “a” to the location of keyframe “b.” By way of example, the time period is 10 seconds. The HotSpot icon 104 should also move from the location of keyframe “a” to the location of keyframe “b” in the same amount of time, i.e. 10 seconds. Referring to FIG. 14c, when a particular HotSpot is selected in the list of applied HotSpots, the keyframes a, b, c and travel path (dotted line) are displayed in the video viewing area. The keyframes a, b, c can be displayed as ghosted or dimmed. As the video 82 plays (or is forwarded or reversed), a dot or other indicator shows the current position of the HotSpot icon. If the timecode matches up with a keyframe a, b, c, then the particular keyframe is highlighted instead of showing the dot. When the video play point is beyond the timecode of the HotSpot, the keyframes and dotted lines can all be ghosted. Referring to FIG. 15, the progress bar can have indications to assist in editing and setting the positions of the HotSpot icon. One alternative way of changing the position of the HotSpot icon in relation to the change of position of the content item is by using Bezier curves.

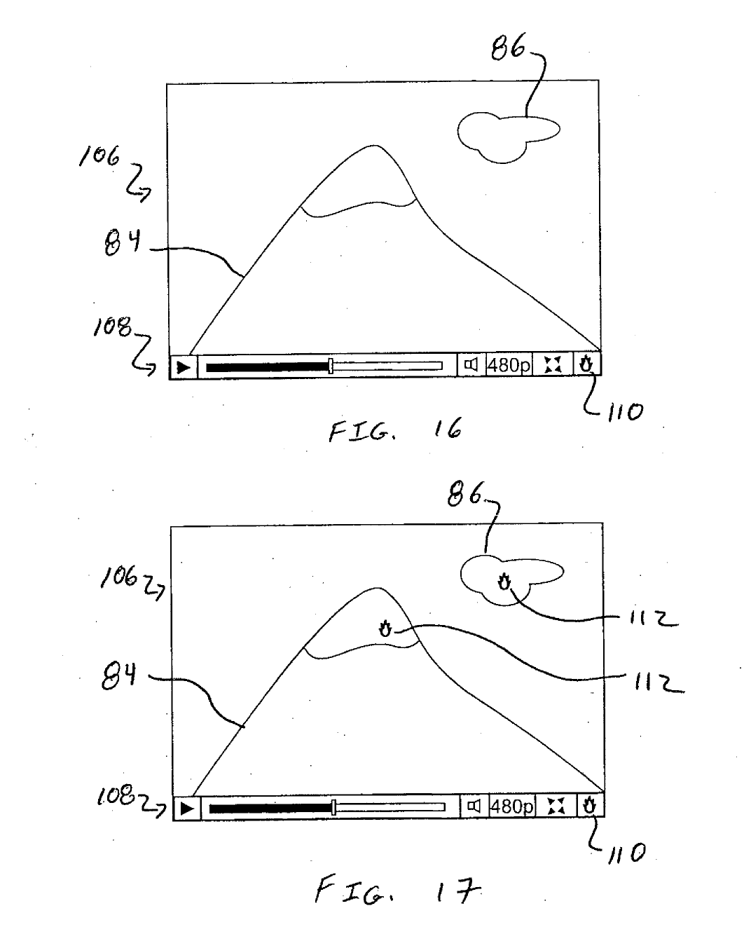

Referring to FIGS. 16-19, embodiments of the present invention will be described regarding playing of the video 82 enhanced with HotSpots. FIG. 16 shows a display screen playing the video 82 enhanced with HotSpots (the HotSpots are not yet shown in FIG. 16). The display screen has a video portion 106 and a progress bar portion 108. A HotSpot toggle icon 110 is also provided. The HotSpot toggle icon 110 can be actuated to toggle the HotSpots on and off FIG. 17 shows the HotSpots toggled on with HotSpot icons 112 appearing in the video 82 by the mountain 84 and the cloud 86.

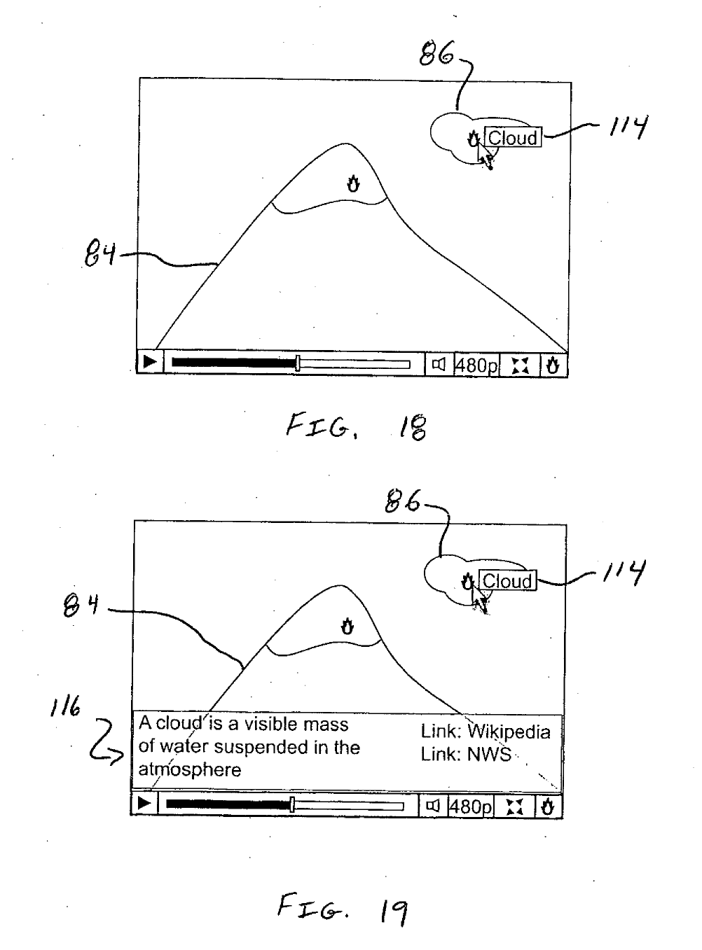

Referring to FIG. 18, a HotSpot icon 112 can be actuated in two modes. When the curser is placed over the HotSpot icon 112 without clicking on the icon 112, the HotSpot icon 112 is actuated in a first mode. In the first mode some information, such as a brief label or description 114, is displayed. The information 114 may be displayed adjacent the content item. As shown in FIG. 18, the label “Cloud” is displayed when the curser is placed on the HotSpot icon 112 by the cloud 86.

The HotSpot icon 112 is actuated in a second mode when the user clicks on the icon 112. FIG. 19 shows the HotSpot icon 112 on the cloud 86 being actuated in the second mode. Clicking on the cloud HotSpot icon 112 presents or displays additional information 116 about the content item (the cloud 86). For example, a transparent overlay appears in the video 82 with a plurality of actuatable links. The user can then click on the desired link and further information from outside of the video 82 can be displayed. The information may be displayed in a separate portion or window of the display screen different from the portion playing the video 82. Each link can be associated with any desired source of information, including without limitation, information stored locally to the video player or information remote from the video player, such as from the Internet. The display of the information and/or the links can be removed from view by the user. For example, if the user moves the curser away from the transparent overlay and clicks on the video 82. Other suitable actions can be used to remove the information and/or links from view.

When a user clicks on the HotSpot icon 112 overlaid on the video 82, the progress bar may display indications where that particular content item appears throughout the video 82. The indications may be vertical bars, for example. The indications may be color coded or have other visual differences to distinguish between multiple content items, e.g., one color for all appearance locations of the mountain 84 and another color for all appearance locations of the cloud 86.

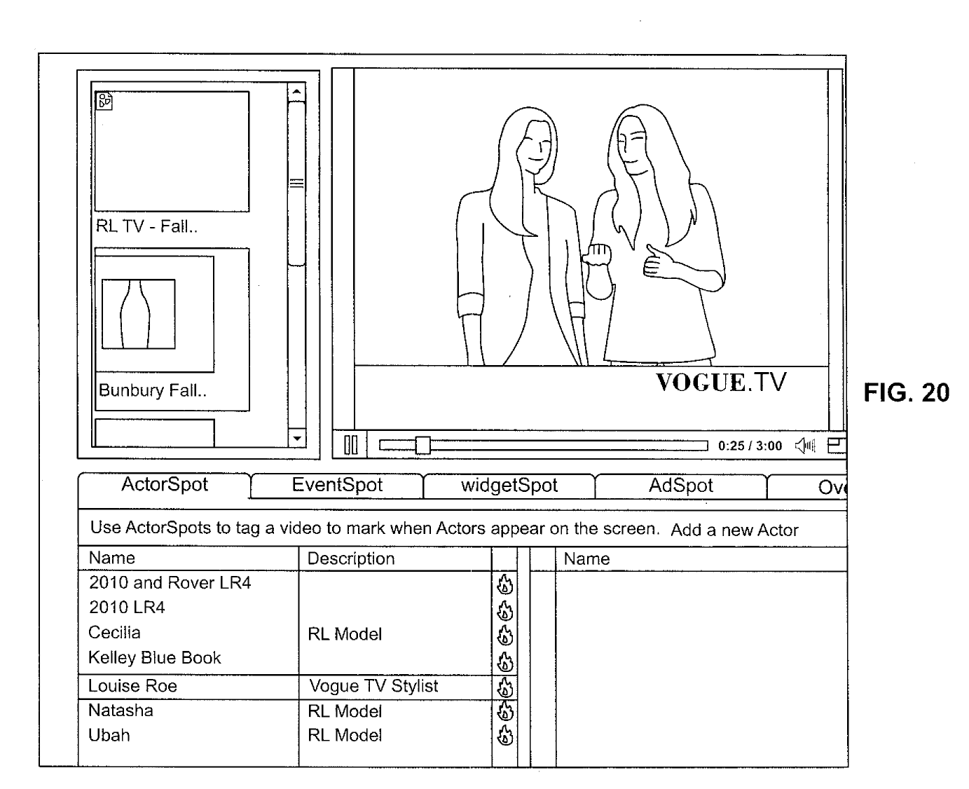

FIG. 20 shows another embodiment of the present invention. FIG. 20 is a screen shot from a display screen of the HotSpotOpsDesign system for applying a HotSpot icon to the video. The HotSpotOpsDesign system shown in FIG. 20 is similar to what was shown and described in FIGS. 9-13. However, HotSpotOpsDesign system of FIG. 20 includes the ability to apply various different types of HotSpots. FIG. 20 shows an example an ActorSpot type of HotSpot being created. However, other types of HotSpots, such as EventSpot, WidgetSpot, AdSpot, OverlaySpot, etc., can be similarly created and used.

A video showing two actresses is playing in a video portion of the display screen. The video can be started by clicking on a video play button as is know in the art. One alternative is for the HotSpotOpsDesign system to have a plurality of available videos. An index of the available videos is shown in FIG. 9 to the left of the video portion of the display screen. An operator or spotter can select a desired video from the index of videos and play the selected video on the display screen. As the spotter watches the video selects a desired tab of the ActorSpot tab, EventSpot tab, WidgetSpot tab, AdSpot tab and OverlaySpot tab by clicking on the desired tab with a mouse, for example. In this example, the spotter has selected the ActorSpot tab. The ActorSpot HotSpot is created (added to the video) as described above for other HotSpots.

Various aspects of the present invention have been described as pointing a curser at an item, such as an icon, and clicking on the item or icon. The present invention is not limited to any particular pointing and clicking device. The present invention contemplates any suitable pointing mechanism or process of interfacing with the present invention. Examples of some suitable interfaces include without limitation, computer mice, touch pads, joysticks, and touch screens, etc.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical.” Numerous modifications and adaptations will be readily apparent to those skilled in this art without departing from the spirit and scope of the present invention.

The invention is claimed as follows:

1. A method for presenting information associated to video content, comprising:
displaying a video;
displaying a content item in the video;
displaying an icon in relation to the content item, the icon associated with a link to information outside of the video;
actuating the icon and the link; and
presenting the information outside of the video in response to actuation of the icon and link.

2. The method for presenting information associated to video content of claim 1, wherein actuating the icon and the link comprises rolling a pointer over the icon.

3. The method for presenting information associated to video content of claim 1, wherein actuating the icon and the link comprises clicking on the icon.

4. The method for presenting information associated to video content of claim 1, wherein actuating the icon and the link touching a touch screen at a location of the icon.

5. The method for presenting information associated to video content of claim 1, wherein presenting the information outside of the video in response to actuation of the icon and link comprises providing a plurality of user selectable and actuatable links, each user selectable and actuatable link associated with information outside of the video.

6. The method for presenting information associated to video content of claim 1, wherein actuating the icon and the link comprises:
actuating the icon and the link in a first mode and presenting a first portion of information from outside of the video; and
actuating the icon and the link in a second mode and presenting a second portion of information from outside of the video.

7. The method for presenting information associated to video content of claim 6, wherein presenting a first portion of information from outside of the video in the first mode comprises displaying the information adjacent the content item.

8. The method for presenting information associated to video content of claim 6, wherein presenting a second portion of information from outside of the video in the second mode comprises displaying a plurality of user selectable and actuatable links, each user selectable and actuatable link associated with information outside of the video.

9. The method for presenting information associated to video content of claim 8, wherein displaying a plurality of user selectable and actuatable links comprises displaying a transparent overlay over a portion of the video.

10. The method for presenting information associated to video content of claim 9, wherein displaying a video comprises displaying the video on a portion of a video screen; and
further comprising displaying information on another portion of the video screen in response to actuation of the user selectable and actuatable link.

11. The method for presenting information associated to video content of claim 1, wherein:
displaying a video comprises displaying the video in a video display portion of a video screen; and
displaying an icon in the video display portion of the video screen in relation to the content item comprises displaying the icon in the video display portion of the video screen.

12. The method for presenting information associated to video content of claim 11, wherein actuating the icon and the link comprises:
actuating the icon and the link in a first mode and presenting a first portion of information from outside of the video in the video display portion; and
actuating the icon and the link in a second mode and presenting a second portion of information from outside of the video.

13. The method for presenting information associated to video content of claim 12, wherein presenting a second portion of information from outside of the video in the second mode comprises displaying a plurality of user selectable and actuatable links, each user selectable and actuatable link associated with information outside of the video.

14. The method for presenting information associated to video content of claim 13, wherein displaying a plurality of user selectable and actuatable links comprises displaying a transparent overlay over a portion of the video.

15. The method for presenting information associated to video content of claim 13, further comprising displaying information on a portion of the video screen different from the video display portion in response to actuation of the user selectable and actuatable link.

16. The method for presenting information associated to video content of claim 1, further comprising:
displaying a video progress bar; and
displaying on the video progress bar locations of the content item in the video when the icon is actuated.

17. The method for presenting information associated to video content of claim 1, further comprising toggling the display of the icon on and off.

18. The method for presenting information associated to video content of claim 11, further comprising displaying a video progress bar in a portion of the video screen.

19. The method for presenting information associated to video content of claim 11, further comprising:
displaying a video progress bar; and
displaying on the video progress bar locations of the content item in the video when the icon is actuated.
